(19) United States
(12) Patent Application Publication
(10) Pub. No.: US 2014/0011165 A1
(43) Pub. Date: Jan. 9, 2014

(54) Little Chef Cooking Tools

(71) Applicants: Betty June Childress, Cabot, AR (US); Katherine Hatcher, Ward, AR (US)

(72) Inventors: Betty June Childress, Cabot, AR (US); Katherine Hatcher, Ward, AR (US)

(21) Appl. No.: 13/930,696

(22) Filed: Jun. 28, 2013

Related U.S. Application Data
(60) Provisional application No. 61/667,757, filed on Jul. 3, 2012.

(51) Int. Cl. G09B 19/00

(52) U.S. Cl. CPC G09B 19/0092
USPC 434/127

(57) ABSTRACT

A cooking aid device is disclosed that uses themes to represent measurements and to help children understand cooking concepts. The cooking aid device comprises a plurality of measuring instruments, such as measuring cups and/or measuring spoons, and a recipe book. The plurality of measuring cups each comprise a symbol to represent a specific measurement. The symbols can be jungle animals, farm animals, sea life animals, shapes, colors, Braille, letters, numbers, etc. The recipe book comprises a plurality of recipes, as well as a plurality of symbols that correspond to the symbols displayed on the plurality of measuring cups. The symbols indicate to a child visually how much of one ingredient to place into a bowl. Thus, a child can visually match one of the plurality of measuring cups with a specific measurement based on the corresponding symbols displayed on the measuring cups and matched to the recipe book.

### CROSS-REFERENCE

This application claims priority from Provisional Patent Application Serial No. 61/667,757 filed Jul. 3, 2012.

### BACKGROUND

The concept of cooking can be difficult for children to understand, and adults may have a hard time trying to properly teach all the steps. Further, an adult may have to purchase multiple products, books, and/or classes in order to teach children how to cook and how to enjoy cooking, which can be expensive and time consuming. An effective and entertaining solution is needed.

The present invention uses various themes to help children understand basic cooking concepts. The cooking aid device uses themes to represent measurements to a child who may or may not be able to read. For example, the recipe book uses an animal (or other theme) to represent a certain measurement, while the measuring spoon or cup may have the corresponding animal, letting the child know how much of an ingredient to put in the mixing bowl. The cooking aid device is designed to get a child interested in cooking, and it serves as a unique activity that can establish a bond between children and adults. Further, the cooking aid device promotes safety and cleanliness in the kitchen. The cooking aid device can also comprise additional stickers for making their own recipes, stencils, and outline drawings for making different shaped bread.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a cooking aid device that uses themes to represent measurements and to help children understand cooking concepts. The cooking aid device comprises a plurality of measuring instruments, such as measuring cups and/or measuring spoons, and a recipe book. The plurality of measuring cups each comprise a top, a bottom, a side wall, and a symbol to represent a specific measurement. The symbols can be any theme that holds the interest of a child, such as jungle animals, farm animals, sea life animals, shapes, colors, Braille, letters, numbers, etc., or any other suitable theme or design as is known in the art. The recipe book comprises a plurality of recipes, instructions, and other cooking-related content, as well as a plurality of symbols that correspond to the symbols displayed on the plurality of measuring cups. The symbols indicate to a child visually how much of one ingredient to place into a bowl. Thus, a child can visually match one of the plurality of measuring cups with a specific measurement based on the corresponding symbols displayed on the measuring cups and matched to the recipe book.

In a preferred embodiment, the cooking aid device comprises a plurality of measuring spoons and/or a plurality of fluid measuring cups. The plurality of measuring spoons and the plurality of fluid measuring cups each comprise a top, a bottom, and a side wall. Furthermore, the plurality of measuring spoons and the plurality of fluid measuring cups each comprise a symbol to represent a specific measurement. The recipe book then comprises a plurality of symbols that correspond to the symbols displayed on the plurality of measuring spoons and the plurality of fluid measuring cups to indicate to a child visually how much of one ingredient to place into a bowl or other container. Thus, a child can visually match one of the plurality of measuring spoons or one of the plurality of fluid measuring cups with a specific measurement based on the corresponding symbols displayed on the measuring spoons or the fluid measuring cups and matched to the recipe book. The cooking aid device can also comprise a plurality of mixing bowls for placing ingredients. The mixing bowls can be various sizes and have easy to grasp handles for the child to hold while mixing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description, when considered in conjunction with the drawings.

### BRIEF DESCRIPTION OF THE DRAWINGS

FIG. 1 illustrates a perspective view of a plurality of measuring cups of the cooking aid device in accordance with the disclosed architecture.

FIG. 2 illustrates a perspective view of a recipe book of the cooking aid device in accordance with the disclosed architecture.

FIG. 3 illustrates a perspective view of a plurality of measuring spoons of the cooking aid device in accordance with the disclosed architecture.

FIG. 4 illustrates a perspective view of a plurality of fluid measuring cups of the cooking aid device in accordance with the disclosed architecture.

FIG. 5 illustrates a perspective view of a mixing bowl of the cooking aid device in accordance with the disclosed architecture.

FIG. 6 illustrates a perspective view of the cooking aid device in use in accordance with the disclosed architecture.

FIG. 7 illustrates a perspective view of additional accessories for the recipe book of the cooking aid device in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof It may be evident, however, that the innovation can be practiced without these specific details. In other instances, well-known structures and devices are shown in block diagram form in order to facilitate a description thereof.

The present invention discloses a cooking aid device that uses various themes to help children understand basic cooking concepts. Specifically, the cooking aid device uses themes to represent measurements to a child who may or may not be able to read. For example, the recipe book uses an animal (or other theme) to represent a certain measurement, while the measuring spoon or cup may have the corresponding animal, letting the child know how much of an ingredient to put in the mixing bowl. The cooking aid device is designed to get a child interested in cooking, and it serves as a unique activity that can establish a bond between children and adults. The cooking aid device can also comprise additional stickers for a child to make their own recipes, stencils, and outline drawings for making different shaped bread.

The disclosed cooking aid device comprises a plurality of measuring instruments, such as measuring cups and/or measuring spoons, and a recipe book. The plurality of measuring cups each comprise a symbol to represent a specific measurement. The symbols can be jungle animals, farm animals, sea life animals, shapes, colors, Braille, letters, numbers, etc. The recipe book comprises a plurality of recipes, as well as a plurality of symbols that correspond to the symbols displayed on the plurality of measuring cups. The symbols indicate to a child visually how much of one ingredient to place into a bowl. Thus, a child can visually match one of the plurality of measuring cups with a specific measurement based on the corresponding symbols displayed on the measuring cups and matched to the recipe book.

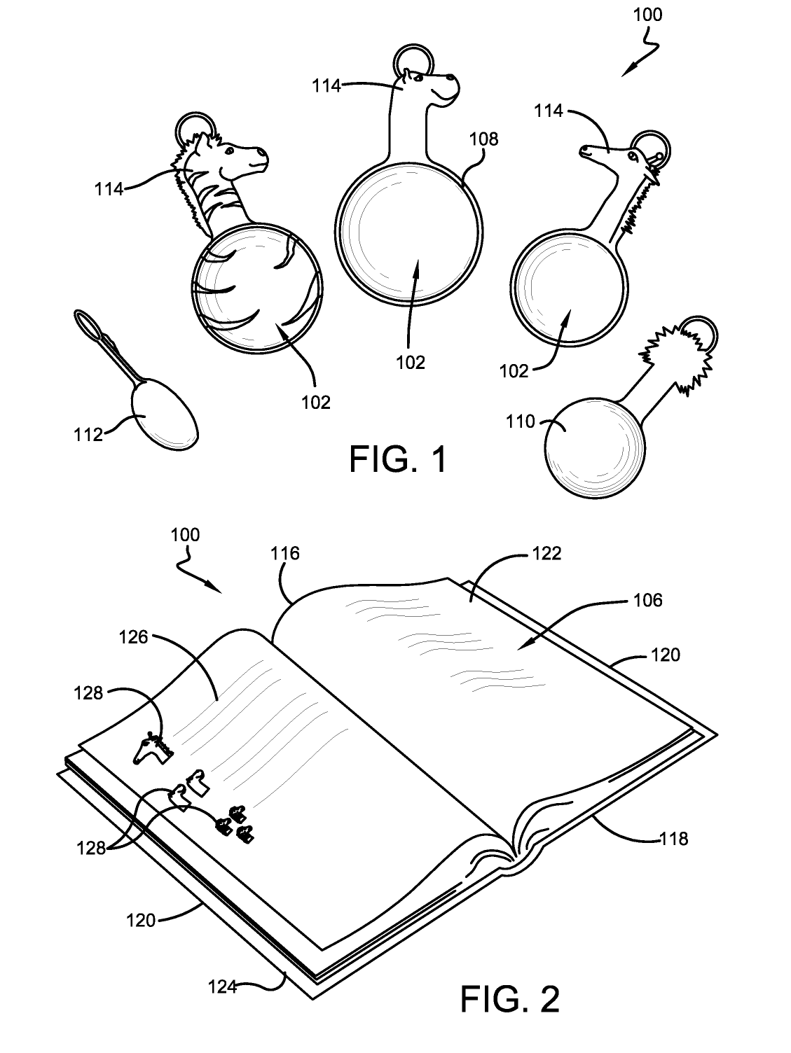

Referring initially to the drawings, FIGS. 1-5 and 7 illustrate the cooking aid device 100 that uses themes to represent measurements and to help children understand cooking concepts. The cooking aid device 100 comprises a plurality of measuring instruments, such as measuring cups 102 or measuring spoons 104, and a recipe book 106.

The plurality of measuring cups 102 each comprise a top 108, a bottom 110, and a side wall 112 (as shown in FIG. 1). Typically, the measuring cup 102 is round and cylindrical in shape, however any other suitable shape can be used as is known in the art without affecting the overall concept of the invention. The measuring cup 102 would generally be constructed of plastic, such as polyvinyl chloride, or metal, such as aluminum, etc., though any other suitable material may be used to manufacture the measuring cup 102 as is known in the art without affecting the overall concept of the invention. The measuring cup 102 can also comprise a variety of colors and designs to suit user and manufacturing preference.

Furthermore, the plurality of measuring cups 102 each comprise a symbol 114 to represent a specific measurement (or volume of ingredient). The symbols 114 can be positioned on any suitable position on the measuring cups 102, such as the handle, the inside of the cup, the back of the cup, etc. The symbols 114 can be any theme that holds the interest of a child, such as jungle animals, farm animals, sea life animals, shapes, colors, Braille, letters, numbers, etc., or any other suitable theme or design as is known in the art.

The cooking aid device 100 further comprises a recipe book 106 comprising a top 116, a bottom 118, and opposing sides 120 (as shown in FIG. 2). Typically, the recipe book 106 is rectangular in shape, however any other suitable shape can be used as is known in the art without affecting the overall concept of the invention. The recipe book 106 would generally be constructed of paper, cardstock, etc., though any other suitable material may be used to manufacture the recipe book 106 as is known in the art without affecting the overall concept of the invention. The recipe book 106 can also comprise a variety of colors and designs to suit user and manufacturing preference. Generally, the recipe book 106 is approximately between 8 and 12 inches long as measured from the top 116 to the bottom 118, and approximately between 4½ and 12 inches wide as measured from opposing sides 120, and approximately between ¼ and 1½ inches thick as measured from a front surface 122 to a back surface 124. All measurements are at the manufacturer's discretion.

Furthermore, the recipe book 106 comprises a plurality of recipes 126, stickers, instructions, pictures, and other cooking-related content. The recipe book 106 also comprises a plurality of symbols 128 that correspond to the symbols 114 displayed on the plurality of measuring cups 102 to indicate to a child visually how much of each ingredient to place into a bowl. The symbols 128 can be any theme that holds the interest of a child, such as jungle animals, farm animals, sea life animals, shapes, colors, Braille, letters, numbers, etc., or any other suitable theme or design as is known in the art. Thus, a child can visually match one of the plurality of measuring cups 102 with a specific measurement based on the corresponding symbols displayed on the measuring cups 102 and matched to the recipe book 106.

For example, a dog could equal 1 cup, and a snake could equal 1 fluid ounce, so the 1 cup measuring cup would have a picture of a dog on it and the 1 fluid ounce line on the fluid measuring cup would have a picture of a snake on it. Then, if a recipe called for 1 cup of flour, a picture of a dog would be shown in the recipe book next to the word or picture of flour, and if the recipe called for 1 fluid ounce of water, a picture of a snake would be shown in the recipe book next to the word or picture of water. A child would see the picture of the dog and the picture of the snake and be able to recognize which measuring cup and which fluid measuring cup to use for the recipe and would visually know how much of one ingredient to place in a mixing bowl.

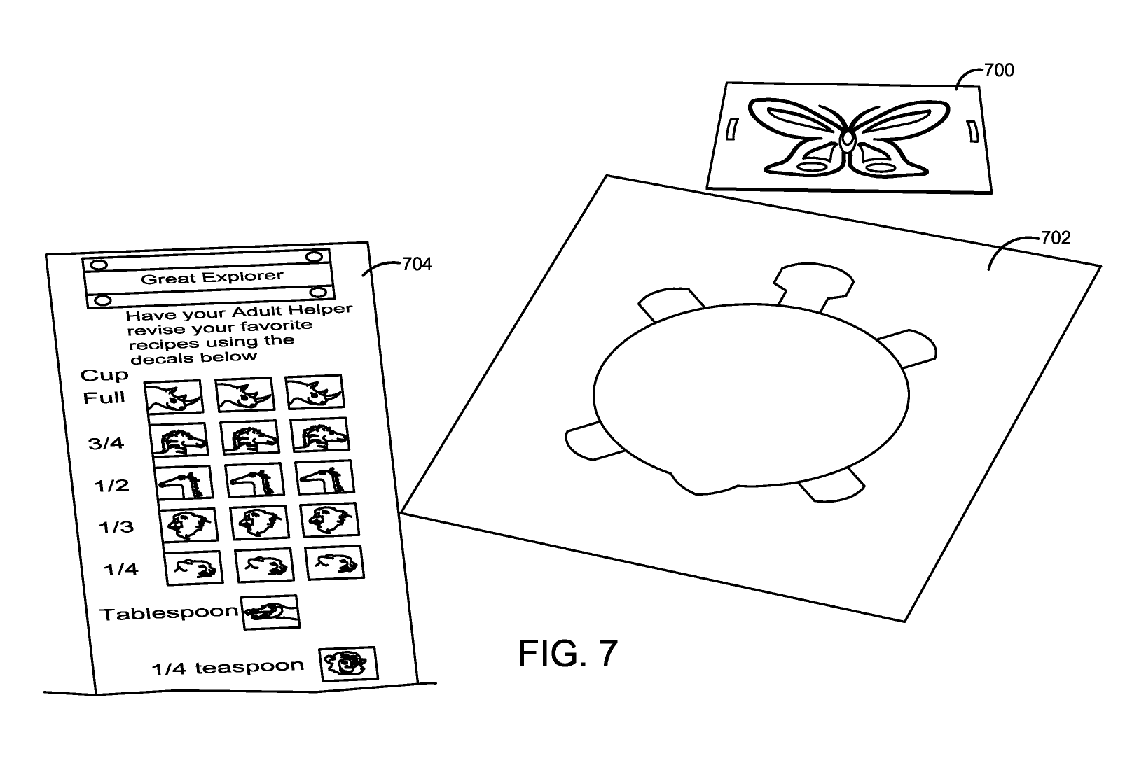

Additionally, the recipe book 106 can comprise additional stickers 704 representing the specific measurement devices and corresponding symbols, such that a user can revise recipes according to their own likes/dislikes and can create new recipes in the recipe book 106 by adding stickers 704. The recipe book 106 also includes outlined drawings 702 for making bread shapes or other dough shapes, and stencils 700 for decorating the food items created. The stencils 700 would have at least one handle such that a small child could easily use and remove the stencil 700 (as shown in FIG. 7).

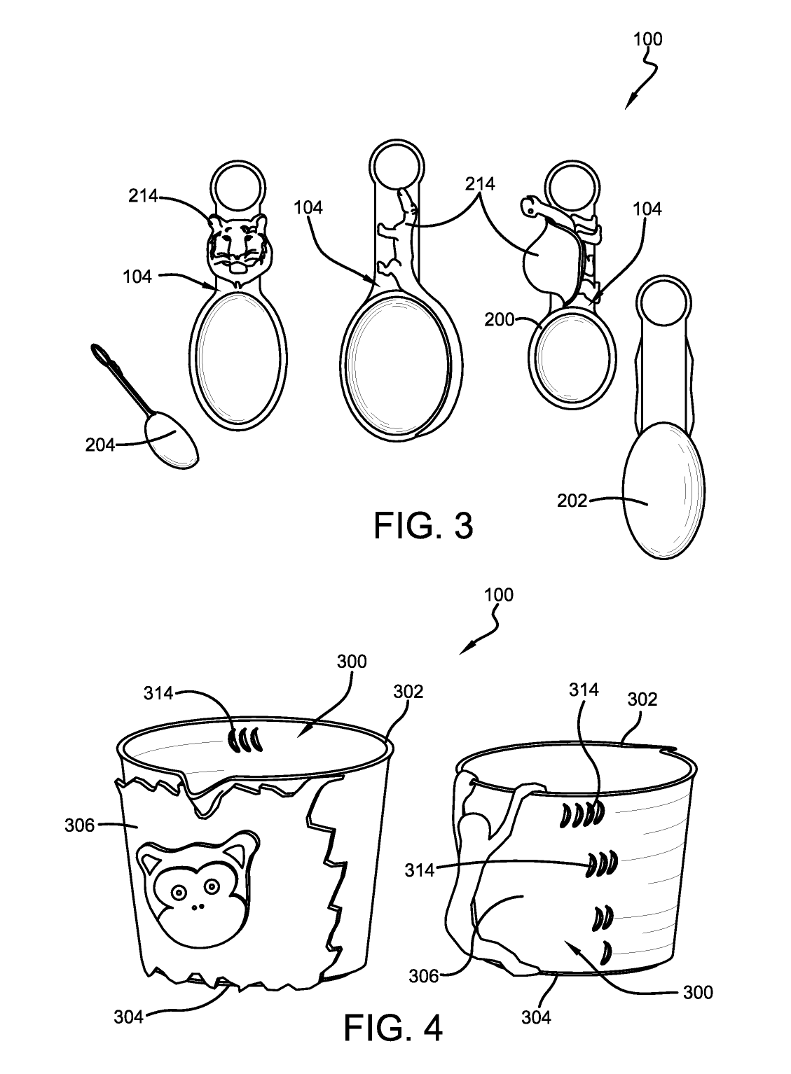

Furthermore, the cooking aid device 100 comprises a plurality of measuring spoons 104. The plurality of measuring spoons 104 each comprise a top 200, a bottom 202, and a side wall 204 (as shown in FIG. 3). Typically, the measuring spoon 104 is round and bowl-like in shape, however any other suitable shape can be used as is known in the art without affecting the overall concept of the invention. The measuring spoon 104 would generally be constructed of plastic, such as polyvinyl chloride, or metal, such as aluminum, etc., though any other suitable material may be used to manufacture the measuring spoon 104 as is known in the art without affecting the overall concept of the invention. The measuring spoon 104 can also comprise a variety of colors and designs to suit user and manufacturing preference.

Furthermore, the plurality of measuring spoons 104 each comprise a symbol 214 to represent a specific measurement (or volume of ingredient). The symbols 214 can be positioned on any suitable position on the measuring spoons 104, such as the handle, the inside of the spoon, the back of the spoon, etc. The symbols 214 can be any theme that holds the interest of a child, such as jungle animals, farm animals, sea life animals, shapes, colors, Braille, letters, numbers, etc., or any other suitable theme or design as is known in the art.

Furthermore, the recipe book 106 comprises a plurality of symbols 128 that correspond to the symbols 214 displayed on the plurality of measuring spoons 104 to indicate to a child visually how much of one ingredient to place into a bowl. The symbols 128 can be any theme that holds the interest of a child, such as jungle animals, farm animals, sea life animals, shapes, colors, Braille, letters, numbers, etc., or any other suitable theme or design as is known in the art. Thus, a child can visually match one of the plurality of measuring spoons 104 with a specific measurement based on the corresponding symbols displayed on the measuring spoons 104 and matched to the recipe book 106.

Furthermore, the cooking aid device 100 comprises a plurality of fluid measuring cups 300. The plurality of fluid measuring cups 300 each comprise a top 302, a bottom 304, and a side wall 306 (as shown in FIG. 4). Typically, the fluid measuring cup 300 is round and cylindrical in shape, however any other suitable shape can be used as is known in the art without affecting the overall concept of the invention. The fluid measuring cup 300 would generally be constructed of plastic, such as polyvinyl chloride, or metal, such as aluminum, etc., though any other suitable material may be used to manufacture the fluid measuring cup 300 as is known in the art without affecting the overall concept of the invention. The fluid measuring cup 300 can also comprise a variety of colors and designs to suit user and manufacturing preference.

Furthermore, the plurality of fluid measuring cups 300 each comprise a symbol 314 to represent a specific measurement (or volume of ingredient). The symbols 314 can be positioned on any suitable position on the fluid measuring cups 300, such as the handle, the inside of the cup, the back of the cup, etc. The symbols 314 can be any theme that holds the interest of a child, such as jungle animals, farm animals, sea life animals, shapes, colors, Braille, letters, numbers, etc., or any other suitable theme or design as is known in the art.

Furthermore, the recipe book 106 comprises a plurality of symbols 128 that correspond to the symbols 314 displayed on the plurality of fluid measuring cups 300 to indicate to a child visually how much of one ingredient to place into a bowl. The symbols 128 can be any theme that holds the interest of a child, such as jungle animals, farm animals, sea life animals, shapes, colors, Braille, letters, numbers, etc., or any other suitable theme or design as is known in the art. Thus, a child can visually match one of the plurality of fluid measuring cups 300 with a specific measurement based on the corresponding symbols displayed on the fluid measuring cups 300 and matched to the recipe book 106.

Additionally, the cooking aid device 100 can comprise any other measuring instrument that can be used for cooking, measuring, and the like. These measuring instruments can be coded with a symbol to represent a specific measurement (or volume of ingredient). The symbols can be positioned on any suitable position on the measuring instruments, such as the handle, or the inside or outside surface, etc. The symbols can be any theme that holds the interest of a child, such as jungle animals, farm animals, sea life animals, shapes, colors, Braille, letters, numbers, etc., or any other suitable theme or design as is known in the art. Furthermore, the recipe book 106 comprises a plurality of symbols 128 that correspond to the symbols displayed on the measuring instruments to indicate to a child visually how much of one ingredient to place into a bowl.

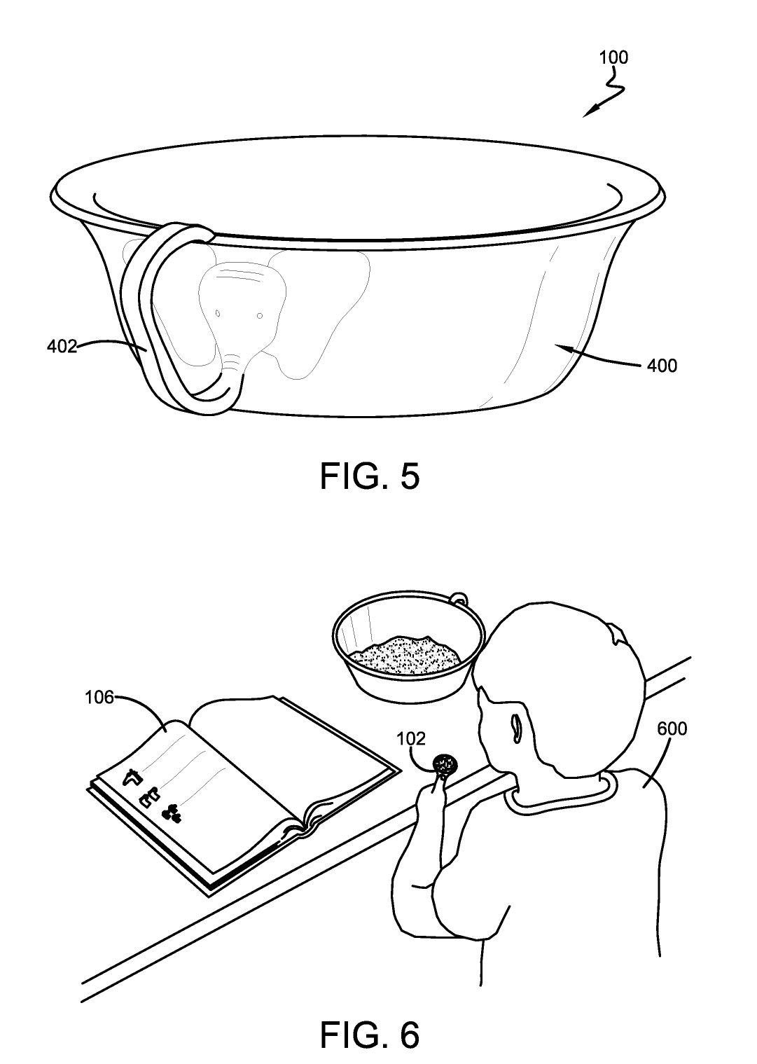

The cooking aid device 100 can also comprise a plurality of mixing bowls 400 for placing ingredients. The mixing bowls 400 can be color coded to represent various sizes and/or uses, or can be marked with symbols in a fashion similar to that described above, and can have easy to grasp handles 402 for the child to hold while mixing, and a pour spout for pouring liquid ingredients from the bowls 400 (as shown in FIG. 5). The cooking aid device 100 can comprise any other cooking or baking device or implement/instrument as is known in the art. These cooking or baking devices can also be color coded or be marked with symbols in a fashion similar to that described above to represent various sizes and/or uses.

FIG. 6 illustrates the cooking aid device 100 in use. In operation, a user 600 would open the recipe book 106 and choose the type of recipe 126 that meets their needs and/or wants. The user 600 would then assemble all of the needed ingredients for the recipe 126 together. The user 600 would then visually match the symbols 128 within the recipe 126 to the measuring instruments, such as measuring cups 102 and/or measuring spoons 104.

The user 600 can then determine how much of one ingredient to place in a mixing bowl. For example, if a picture of a dog equals 1 cup. Then, next to the word (or picture) of flour, there could be a picture of a dog. The user 600 would then find the measuring cup with a picture of a dog on it, and would know how much flour to add to the mixing bowl. The user 600 would then use the measuring cup 102 to scoop up the flour and would pour the flour into a mixing bowl 400.

The user would then continue measuring out the ingredients for the recipe, using the symbols 128 within the recipe 126 and matching those symbols 128 with the corresponding symbols on the measuring instruments (i.e., measuring cups, spoons, etc.). The user 600 would then continue to follow the recipe 126 as instructed in making the food item.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cooking aid device for children comprising:
a plurality of measuring cups, wherein each measuring cup comprises a top, a bottom, a side wall, and a symbol that corresponds to a specific measurement; and
a recipe book, wherein the recipe book comprises a plurality of symbols that correspond to the symbols displayed on the plurality of measuring cups, such that a child can visually match one of the plurality of measuring cups with a specific measurement.

2. The cooking aid device of claim 1, further comprising a plurality of measuring spoons, wherein each measuring spoon comprises a symbol to represent a specific measurement.

3. The cooking aid device of claim 2, wherein the recipe book further comprises a plurality of symbols that correspond to the symbols displayed on the plurality of measuring spoons, such that a child can visually match one of the plurality of measuring spoons with a specific measurement.

4. The cooking aid device of claim 1, further comprising a plurality of mixing bowls for placing ingredients.

5. The cooking aid device of claim 1, further comprising a plurality of fluid measuring cups, wherein each fluid measuring cup comprises a symbol to represent a specific measurement.

6. The cooking aid device of claim 5, wherein the recipe book further comprises a plurality of symbols that correspond to the symbols displayed on the plurality of fluid measuring cups, such that a child can visually match one of the plurality of fluid measuring cups with a specific measurement.

7. The cooking aid device of claim 1, wherein the plurality of symbols comprise jungle animals.

8. The cooking aid device of claim 1, wherein the plurality of symbols comprise sea life animals.

9. The cooking aid device of claim 1, wherein the plurality of symbols comprise farm animals.

10. The cooking aid device of claim 1, wherein the plurality of symbols comprise at least one of colors, shapes, Braille, letters, or numbers.

11. A cooking aid device for children comprising:
a plurality of measuring cups, wherein each measuring cup comprises a symbol to represent a specific measurement;
a plurality of mixing bowls for placing ingredients; and
a recipe book, wherein the recipe book comprises a plurality of symbols that correspond to the symbols displayed on the plurality of measuring cups, such that a child can visually match one of the plurality of measuring cups with a specific measurement.

12. The cooking aid device of claim 11, further comprising a plurality of fluid measuring cups, wherein each fluid measuring cup comprises a symbol to represent a specific measurement.

13. The cooking aid device of claim 12, wherein the recipe book further comprises a plurality of symbols that correspond to the symbols displayed on the plurality of fluid measuring cups, such that a child can visually match one of the plurality of fluid measuring cups with a specific measurement.

14. The cooking aid device of claim 11, further comprising a plurality of measuring spoons, wherein each measuring spoon comprises a symbol to represent a specific measurement.

15. The cooking aid device of claim 14, wherein the recipe book further comprises a plurality of symbols that correspond to the symbols displayed on the plurality of measuring spoons, such that a child can visually match one of the plurality of measuring spoons with a specific measurement.

16. The cooking aid device of claim 11, wherein the plurality of symbols comprise at least one of jungle animals, farm animals, or sea life animals.

17. A cooking aid device for children comprising:
a plurality of measuring cups, wherein each measuring cup comprises a specific animal to represent a specific measurement;
a plurality of measuring spoons, wherein each measuring spoon comprises a specific animal to represent a specific measurement;
a plurality of mixing bowls for placing ingredients; and
a recipe book, wherein the recipe book comprises a plurality of animals that correspond to the animals displayed on the plurality of measuring cups and on the plurality of measuring spoons, such that a child can visually match one of the plurality of measuring cups or one of the plurality of measuring spoons with a specific measurement.

18. The cooking aid device of claim 17, further comprising a plurality of fluid measuring cups, wherein each fluid measuring cup comprises a specific animal to represent a specific measurement.

19. The cooking aid device of claim 18, wherein the recipe book further comprises a plurality of animals that correspond to the animals displayed on the plurality of fluid measuring cups, such that a child can visually match one of the plurality of fluid measuring cups with a specific measurement.

20. The cooking aid device of claim 17, wherein the plurality of animals comprise at least one of jungle animals, farm animals, or sea life animals.

21. The cooking aid device of claim 17, further comprising a plurality of stencils with handles and at least one symbol, wherein the at least one symbol comprises at least one of jungle animals, farm animals, sea life animals, shapes, colors, Braille, letters, or numbers.
